(19) United States
(12) Patent Application Publication
(10) Pub. No.: US 2012/0326942 A1
(43) Pub. Date: Dec. 27, 2012

(54) Sectorized Antenna

(75) Inventors: William Davis Simmons, Gilroy, CA (US); Vadim Piskun, San Jose, CA (US)

(73) Assignee: BROADCOM CORPORATION, Irvine, CA (US)

(21) Appl. No.: 13/165,666

(22) Filed: Jun. 21, 2011

(51) Int. Cl. H01Q 3/24

(52) U.S. Cl. 343/876

(57) ABSTRACT

Provided is a sectorized antenna. For example, there is a sectorized antenna including a plurality of antenna elements situated radially around a central axis, where each of the plurality of antenna elements corresponds to at least one of another plurality of sectors of the antenna. A first switch of the sectorized antenna is configured to selectively couple a first transceiver circuit to each antenna element in a first group of the plurality of antenna elements, where the selective coupling provides a configurable directionality for the antenna.

### BACKGROUND OF THE INVENTION

1. Field of the Invention

The present invention relates generally to antennas. More particularly, the present invention relates to sectorized antennas.

2. Background Art

As wireless communications become more prevalent, there is an increasing burden on wireless communications systems to operate at an overall lower cost but with ever increasing performance demands. In continuation with this trend, there have been attempts to integrate wireless communications systems into an increasing variety of electronic devices. Unfortunately, conventional wireless communications systems are typically too bulky or too costly to integrate into smaller electronic devices, especially where there is a need for relatively long range wireless transmissions.

One relatively large module of a typical conventional wireless communications system is a conventional antenna. Particularly with respect to smaller mobile wireless communications systems, these conventional antennas typically either suffer from a relatively short effective range or from intermittent reception due to misalignment issues, fading or shadow effects. Furthermore, these conventional antennas are typically susceptible to interference with other wireless communications devices attempting to communicate with the same client or server wireless communications system.

Accordingly, there is a need to overcome the drawbacks and deficiencies in the art by providing a low-cost and relatively compact antenna offering an increased effective range while being relatively insusceptible to misalignment and interference issues.

### SUMMARY OF THE INVENTION

The present application is directed to a sectorized antenna, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a sectorized antenna, according to one embodiment of the present invention;

FIG. 2 presents a diagram of a sectorized antenna, according to one embodiment of the present invention;

FIG. 3 presents a diagram of a transceiver circuit for a sectorized antenna, according to one embodiment of the present invention;

FIG. 4 presents a diagram of a transceiver circuit for a sectorized antenna, according to one embodiment of the present invention;

FIG. 5 presents a diagram of a transceiver circuit for a sectorized antenna, according to one embodiment of the present invention.

### DETAILED DESCRIPTION OF THE INVENTION

The present application is directed to a sectorized antenna. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. Unless noted otherwise, like or corresponding elements among the figures may be indicated by like or corresponding reference numerals. Moreover, the drawings and illustrations in the present application are generally not to scale, and are not intended to correspond to actual relative dimensions.

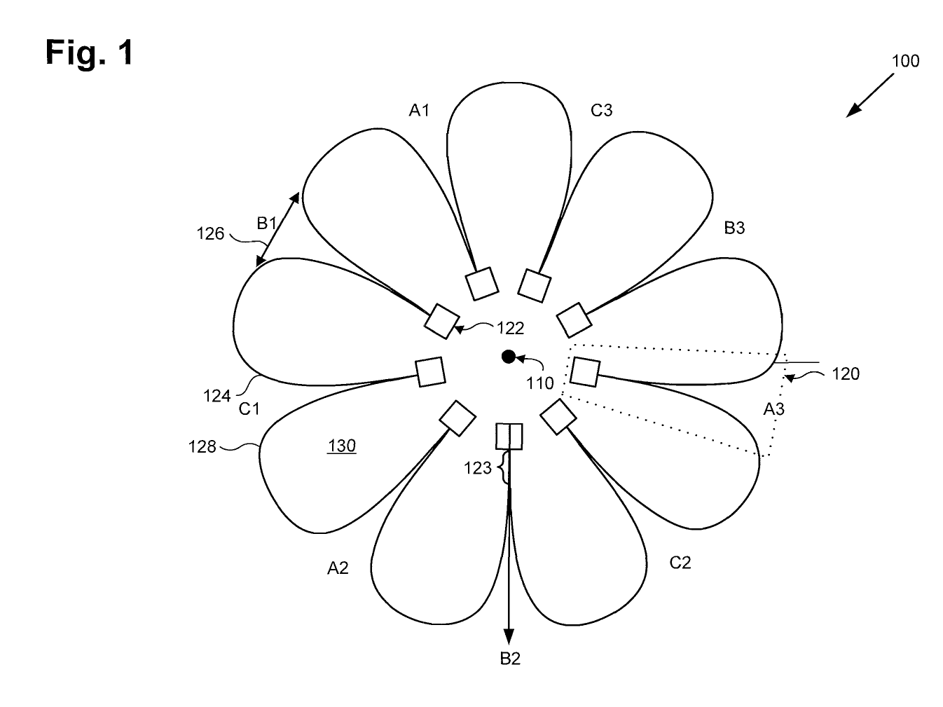

FIG. 1 shows one embodiment of a sectorized antenna addressing the undesirable characteristics of conventional antennas described above. As shown in FIG. 1, sectorized antenna 100 includes central axis 110 and antenna element 120, balun structure 122, slotline 123, exponential flare profile 124, aperture 126 and discontinuity 128 patterned out of conductive layer 130. Also shown in FIG. 1 are antenna element designations A1 through A3, B1 through B3 and C1 through C3 that are used herein to simplify discussion of groups of antenna elements of sectorized antenna 100.

As can be intuited from FIG. 1, sectorized antenna 100 may comprise a plurality of antenna elements, similar to antenna element 120 for example, situated radially around central axis 110, where each of the plurality of antenna elements corresponds to at least one sector of sectorized antenna 100, as will be described more fully below. In the embodiment shown in FIG. 1, each antenna element may include a balun structure, such as balun structure 122 for example. A balun structure may be configured to interface an antenna element to a feed line, for example, such as a microstrip feed line. For instance, a microstrip feed line (not shown in FIG. 1) may be situated in a substrate, such as a printed circuit board (PCB) substrate, for example, and comprise further balun structures to form a low-loss high bandwidth interface to one or more antenna elements of sectorized antenna 100. In some embodiments, such substrate may be adhered to at least a portion of sectorized antenna 100 to form a relatively rigid structure. As such, one or more antenna elements of sectorized antenna 100 may comprise a microstrip fed antenna element, where each microstrip fed antenna element is coupled to its own microstrip feed line that can lead to, for example, transceiver circuitry.

Although balun structure 122 is shown as a rectangular cavity in conductive layer 130 (e.g., a rectangular shape patterned through conductive layer 130, for example), it should be understood that balun structure 122 may comprise other shapes, for example, configured to interface an antenna element of sectorized antenna 100 with a feed line according to specific bandwidth, geometry, and other requirements.

Each antenna element in FIG. 1 may also comprise a slotline, such as slotline 123 for example, that may be used to couple a balun structure to a remainder of the antenna element. For example, slotline 123 may comprise a homogenously thick cavity in conductive layer 130 (e.g., a thin rectangular slot patterned through conductive layer 130) that is configured to couple electromagnetic waves from balun structure 122 to exponential flare profile 124, for instance. Where an antenna element of a sectorized antenna comprises an exponential flare profile, that antenna element may be referred to as a Vivaldi antenna, which is a unique type of tapered slot antenna particularly suited for very high frequency applications (e.g., greater than 1 GHz).

Also shown in FIG. 1 is aperture 126 defined by one or more edge discontinuities, such as discontinuity 128 for example, in a flare profile of a constituent antenna element. As depicted in FIG. 1, aperture 126 refers to a physical structure of sectorized antenna 100, for example, and is not meant to refer to an effective area (e.g., an effectiveness at receiving power of incident radio waves) of sectorized antenna 100. Although not required for proper operation of an antenna element, discontinuity 128 may be used to specify a particular physical aperture size of an antenna element, for example. For instance, a discontinuity such as discontinuity 128 situated at an end of an exponential flare profile of an antenna element may act to effectively eliminate electromagnetic wave propagation from an edge of conductive layer 130 that is beyond discontinuity 128, with respect to, for example, antenna element C1. In some embodiments, a low frequency bound for a particular antenna element, such as the antenna elements shown in FIG. 1, may be set, at least in part, by specifying a particular physical aperture size. In similar fashion, an overall frequency response and upper frequency bound may be determined, in part, by choosing a particular balun structure shape and/or a particular exponential curve for exponential flare profile 124. Any remaining connecting structure of a particular arrangement of antenna elements, such as that shown in FIG. 1, may be patterned out of conductive layer 130 as inexpensively and compactly as possible, for example, such as the substantially linear profile edge segments comprising an edge portion of conductive layer 130 situated between discontinuities of adjacent antennas, as illustrated by the embodiment shown in FIG. 1.

Conductive layer 130 may comprise any contiguous layer of conductive material, for example, that can be patterned into a sectorized antenna comprising multiple antenna elements. As such, in some embodiments, a plurality of antenna elements of sectorized antenna 100 may comprise a single pattern formed in conductive layer 130. For instance, in some embodiments, conductive layer 130 may comprise a metalized ground plane of a PCB or a silicon wafer, for example, that can be lithographically patterned into a plurality of antenna elements forming sectorized antenna 130. Conductive layer 130 may comprise a thickness selected to help provide a particular frequency response for each antenna element patterned out of conductive layer 130, for example.

In some embodiments, sectorized antenna 100 may be formed such that cavities patterned into conductive layer 130, such as balun 122, slotline 123 and exponential flare profile 124 for example, are filled with air, for instance, or are at vacuum. In other embodiments, such cavities may instead be filled with a dielectric material configured to facilitate each individual antenna element having a particular frequency response. For example, a dielectric-filled sectorized antenna may include a dielectric material filling each of a balun, slotline and exponential flare profile of one or more antenna elements up to an aperture, for example, such that each dielectric-filled antenna element may have a frequency response substantially similar to that of a physically larger antenna element, for instance.

Although sectorized antenna 100 is shown in FIG. 1 as being substantially symmetric, in other embodiments, sectorized antenna 100 may comprise differentiated antenna elements. Moreover, although sectorized antenna 100 is shown as comprising 9 antenna elements, in other embodiments, sectorized antenna 100 may comprise fewer or more antenna elements. In particular, in other embodiments, sectorized antenna may comprise as few as two antenna elements situated radially around a central axis, for example, and instead of comprising a full 360 degree circular structure, as shown in FIG. 1, may comprise any subsection of a circular disk, for example, such as a half or quarter disk, for instance, depending on a desired configurable directionality of sectorized antenna 100.

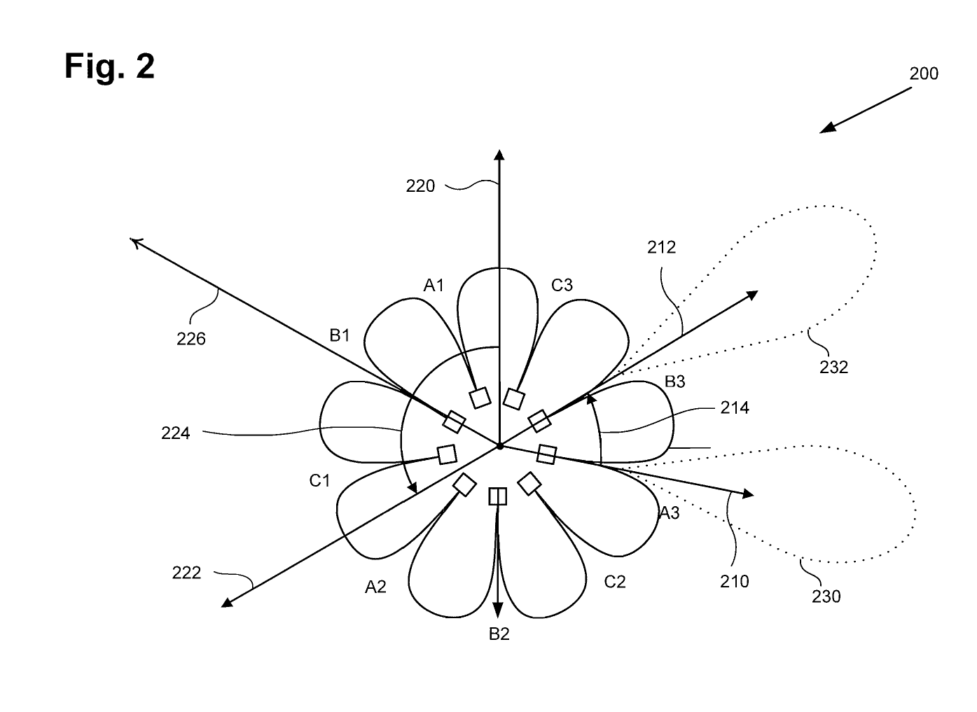

Moving to FIG. 2, FIG. 2 shows sectorized antenna 200 corresponding to sectorized antenna 100 in FIG. 1; e.g., each sectorized antenna may function similarly and comprise the same structure and materials. FIG. 2 also shows adjacent antenna element propagation directions 210 and 212, angle 214 between adjacent antenna elements A3 and B3, first and second sector edges 220 and 222, sector angle 224, sector direction 226, and adjacent radiation patterns 230 and 232 produced by, for example, adjacent antenna elements A3 and B3. It is worth noting that adjacent radiation patterns 230 and 232 are simplified diagrammatic representations of a primary component of radiation patterns produced by adjacent antenna elements A3 and B3 that, in their simplified form, may be used to explain general structural permutations of a sectorized antenna, as described herein.

A sector of a sectorized antenna, such as sectorized antenna 200 in FIG. 2, may comprise one or any number of adjacent antenna elements, for example, and any such sector may be characterized by a sector angle containing that one or those adjacent antenna elements, such as sector angle 224 containing adjacent antenna elements A1, B1 and C1, and a sector direction bisecting that sector angle, such as sector direction 226 bisecting sector angle 224. For example, in a different embodiment, a sector of sectorized antenna 220 may be characterized by the same sector direction 226, but only include antenna element B1 such that its sector angle only contains antenna element B1.

As above, sectorized antenna 200 may comprise differentiated antenna elements, such that some antenna elements are shaped differently or are larger than others, for example, and so sectors of a particular sectorized antenna may also be differentiated to correspond to differentiated antenna elements. Furthermore, sectors of a sectorized antenna may overlap one another. As such, each antenna element of a sectorized antenna may correspond to at least one sector of the sectorized antenna, and in some embodiments, may correspond to multiple sectors of a sectorized antenna.

For example, with respect to the embodiment depicted in FIG. 1, a first sector may be defined by sector angle 224 and sector direction 226 and antenna elements A1, B1 and C1 may correspond to that first sector. A second sector adjacent to the first sector may, in some embodiments, be defined by rotating the first sector counter-clockwise by a single antenna element, for example, and antenna elements B1, C1 and A2 may correspond to the second sector. Such second sector may be characterized by a sector angle equal to but rotated from sector angle 224 and a sector direction substantially in the same direction as a propagation direction for antenna element C1, for example. As shown in FIG. 2, a propagation direction for an antenna element may protrude from a central axis of sectorized antenna 200 and out of an aperture of an antenna element, such as antenna element propagation directions 210 and 212 protruding from apertures of antenna elements B3 and A3.

Although a first and second sector defined as explained above would naturally lead to a sectorized antenna comprising a number sectors equal to a number of antenna elements (e.g., a sector direction corresponding to each antenna element propagation direction), it should be understood that in some embodiments, a total number of defined sectors for a sectorized antenna may be different from a total number of antenna elements of the sectorized antenna. A relationship between sectors and antenna elements of a sectorized antenna may be determined, for example, by circuitry configured to selectively couple one or more antenna elements in the sectorized antenna to, for example, a transceiver. Once this relationship is determined, such coupling circuitry may be used to provide a configurable directionality for a sectorized antenna, as described more fully below.

In particular, a configurable directionality for a circular sectorized antenna like sectorized antenna 200 may substantially extend 360 degrees around a central axis, such as central axis 110 of corresponding sectorized antenna 100 in FIG. 1. However, in other embodiments, a configurable directionality may extend over any smaller number of degrees around such central axis, for example, depending on a shape of sectorized antenna 200 and a number of antenna elements comprising sectorized antenna 200.

Also shown in FIG. 2 are radiation patterns 230 and 232 formed by antenna elements A3 and B3, respectively. Radiation patterns 230 and 232 may represent an effective range of their respective antenna element's transceiving capability (e.g., transmitting and receiving capability), but it should be understood that radiation patterns 230 and 232 are not drawn to the same scale as sectorized antenna 200.

Radiation patterns 230 and 232 may have different shapes depending on a variety of adjustments that can be made to antenna elements A3 and B3 or to circuitry coupled to antenna elements A3 and B3 over, for example, a microstrip feed line. For example, a shape of radiation pattern 230 may depend on a shape of a balun, a length or width of a slotline, a curvature of an exponential flare profile, a size of an aperture, or a thickness of a conductive layer forming antenna element A3, for instance, or even a particular band of frequencies and range of signal amplitudes expected to be transceived by a transceiver circuit coupled to antenna A3.

Thus, for a particular application, each adjacent antenna element of sectorized antenna 200 may be configured such that their adjacent radiation patterns are substantially isolated from one another, similar to radiation patterns 230 and 232 of antennas A3 and B3 shown in FIG. 2. Under such circumstances, each adjacent antenna element may form a substantially independent transmission channel to, for example, a client or server substantially within an effective range of that antenna element's radiation pattern. Furthermore, the plurality of antennas of sectorized antenna 200 may be configured collectively to form corresponding radiation patterns that are all substantially isolated from one another. For example, such isolation may be realized by limiting a number of antenna elements used to form sectorized antenna 200.

In some embodiments, such isolation may allow a sectorized antenna according to the present inventive concepts to maintain a relatively high level of decorrelation between, for example, individual data streams broadcast using corresponding individual antenna elements, for instance, which can increase an overall wireless data rate and/or an effective range as measured between an electronic device comprising sectorized antenna 200, for example, and another wireless electronic device. Furthermore, such isolation may also advantageously decrease antenna heating due to, for example, mutual coupling of transmission signals of adjacent antenna elements, for example.

In other applications, however, it may be beneficial for adjacent antenna elements to form radiation patterns that are not isolated from each other, for example, so as to facilitate beamforming functionality involving mutually coupled antenna elements and their respective mutually coupled radiation patterns, for instance. As with a configured directionality for a sectorized antenna, noted above, such beamforming capabilities depend in part on circuitry configured to selectively couple one or more antenna elements in the sectorized antenna to, for example, a transceiver.

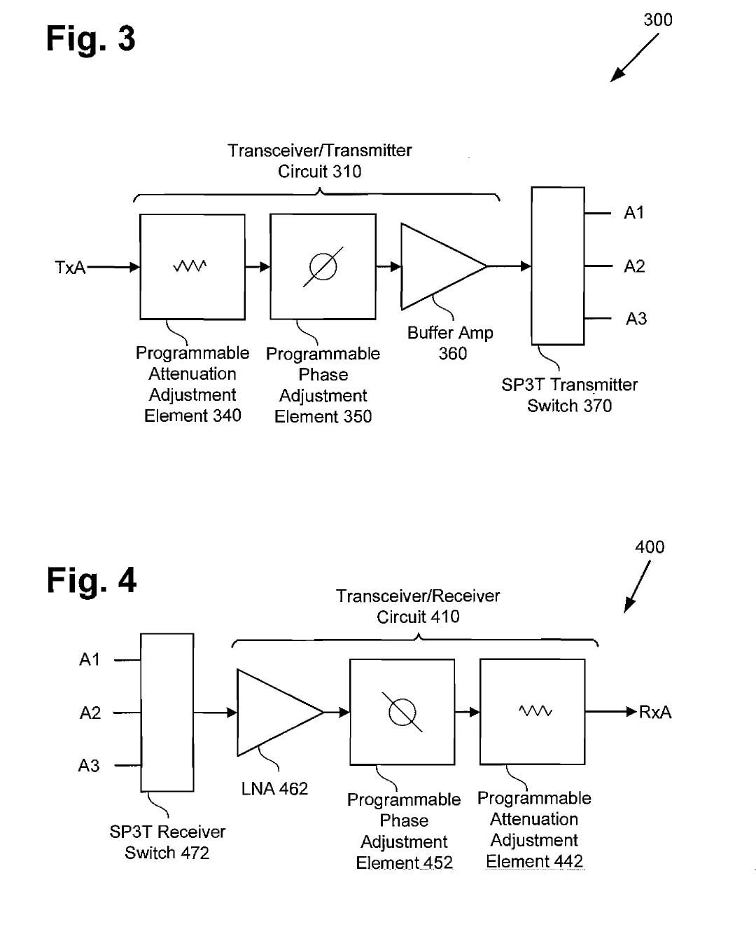

FIG. 3 shows a transceiver circuit 310 configured as a transmitter circuit, for example, that is capable of being coupled to each antenna element in a group of antenna elements of, for example, sectorized antenna 200 in FIG. 2. For example, circuit diagram 300 of FIG. 3 includes both transceiver/transmitter circuit 310 and switch 370 configured selectively couple transceiver circuit 310 to each antenna element A1, A2 and A3 in a first group A of the plurality of antenna elements of sectorized antenna 200 in FIG. 2. As can be seen in FIG. 3, transceiver circuit 310 may be configured to accept an input transmit signal T×A for group A and provide a processed and amplified version of T×A to single-pole-three-terminal (SP3T) switch 370, which in turn can be configured to selectively couple T×A to one of antenna elements A1, A2 or A3 of group A in FIG. 2. Where transceiver circuit 310 is configured as a transmitter, as shown in FIG. 3, switch 370 may be referred to as a transmitter switch for clarity.

Because each antenna element A1, A2 and A3 corresponds to a particular propagation direction, as explained above, a selective coupling of SP3T switch 370 may provide a configurable directionality for sectorized antenna 200, for example. Moreover, assuming the embodiment shown in FIG. 3, such arrangement may provide a configurable transmit directionality for sectorized antenna 200.

Also shown in FIG. 3 are programmable attenuation adjustment element 340, programmable phase adjustment element 350 and buffer amp 360. In some embodiments, a transceiver circuit such as transceiver circuit 310 may include programmable attenuation and phase adjustment elements in order to facilitate transceiving signals with another electronic device, for example, even where each antenna element is configured to form a substantially isolated radiation pattern, as described above. Buffer amp 360 may be configured to amplify and/or provide sufficient current for proper transmission of a transmit signal by, for example, an antenna element of sectorized antenna 200 in FIG. 2.

However, in other embodiments where sectorized antenna is configured such that radiation patterns of adjacent antenna elements are mutually coupled to one another in some manner, for example, programmable attenuation adjustment element 340, programmable phase adjustment element 350 and buffer amp 360 may be configured to facilitate beamforming functionality involving mutually coupled antenna elements and their respective mutually coupled radiation patterns, as noted above. Such beamforming functionality may in turn facilitate a particular set of communications standards, such as multiple input multiple output (MIMO) communications standards, for example.

In all embodiments, programmable attenuation adjustment element 340, programmable phase adjustment element 350, buffer amp 360, and switch 370 may be controlled by a microprocessor of a transceiver, for example, that may be configured to facilitate communications using a sectorized antenna. For example, in some embodiments, each of programmable attenuation adjustment element 340, programmable phase adjustment element 350 and buffer amp 360 may be embodied in software executed by a microprocessor of a transceiver, for example. In other embodiments, transmit signal T×A may include control signals for each of programmable attenuation adjustment element 340, programmable phase adjustment element 350, buffer amp 360, and switch 370.

Although only one transceiver circuit 310 and switch 370 is shown in FIG. 3, it should be clear that embodiments of a fully functional sectorized. antenna 200 may comprise additional transceiver circuits selectively coupled to additional differentiated groups of antenna elements of sectorized antenna 200 using, for example, additional switches. For example, in one symmetric embodiment of sectorized antenna 200, sectorized antenna 200 may include second and third switches selectively coupling second and third transceiver circuits to antenna elements in second and third groups B and C of the plurality of antenna elements of sectorized antenna 200. In one embodiment, each additional transceiver circuit may comprise a transmitter circuit similar to transceiver/transmitter circuit 310 in FIG. 3, thus providing a configurable transmit directionality for sectorized antenna 200 that may include all the possible propagation directions for individual or grouped antenna elements of sectorized antenna 200, as shown in FIG. 2. For example, if only a selection of two adjacent antenna elements is coupled to first and second transmitter circuits, for instance, a configurable directionality for sectorized antenna 200 may include directions that are half way between propagation directions of adjacent antenna elements, such as the direction along first sector edge 220 formed if adjacent antenna elements A1 and C3 are coupled to transmission circuits, for example.

To illustrate, a sectorized antenna may comprise two groups of antenna elements, where adjacent antenna elements are in different groups. A first switch, such as switch 370 in FIG. 3 for example, may be configured to selectively couple a first transceiver circuit, such as transceiver circuit 310 in FIG. 3 for example, to each antenna in one of the two groups.

Likewise, a second switch may be configured to selectively couple a second transceiver circuit to each antenna in the other of the two groups. In such embodiment, the first and second switches may be configured to select one sector of the 2-group sectorized antenna corresponding to a first antenna element of the first group adjacent to a second antenna element of the second group. This concept may be extended to encompass any number of additional differentiated groups of antenna elements (e.g., no antenna element resides in more than one group) and their corresponding additional switches, additional transceiver circuits, and sectors of a sectorized antenna, where the switches are configured to select one sector corresponding to an adjacent selection of antenna elements.

In other embodiments, other transceiver circuits, such as receiver circuits, for example, may be selectively coupled to groups of antenna elements of sectorized antenna 200, for example. One embodiment of such transceiver/receiver circuit is shown in FIG. 4. Circuit diagram 400 of FIG. 4 includes switch 472 and transceiver/receiver circuit 410 comprising low noise amplifier (LNA) 462, programmable phase adjustment element 452 and programmable attenuation adjustment element 442. Similar to switch 370 in FIG. 3, switch 472 may comprise an SP3T switch configured to selectively couple transceiver/receiver circuit 410 to each antenna element A1, A2 and A3 in group A of sectorized antenna 200 shown in FIG. 2. Switch 472 may be referred to as a receiver switch for clarity, but it should be understood that in some embodiments, transmitter and receiver switches may comprise substantially the same structure and only be differentiated with respect to whether they selectively couple a transmitter circuit or a receiver circuit.

LNA 462 may be configured to accept a relatively low signal/noise, unprocessed version of receive signal R×A from switch 472, for example, and provide a higher signal/noise signal though filtering and amplification, for example, to programmable phase adjustment element 452 and programmable attenuation adjustment element 442, which may then provide processed receive signal R×A to a transceiver. As with the programmable elements in FIG. 3, LNA 462, programmable phase adjustment element 452 and programmable attenuation adjustment element 442 may be configured to facilitate isolated reception of receive signals, for example, or may be configured to facilitate communications relying on beamforming functionality involving mutually coupled antenna elements and their respective mutually coupled radiation patterns, as noted above. Moreover, each element of transceiver/receiver circuit 410 may be controlled by a microprocessor of a transceiver, for example, that may be configured to facilitate communications using a sectorized antenna. For example, in some embodiments, each of programmable attenuation adjustment element 442, programmable phase adjustment element 452 and LNA 462 may be embodied in software executed by a microprocessor of a transceiver, for example.

As shown in FIGS. 3 and 4, in some embodiments, a transmitter circuit and its transmitter switch may be coupled to substantially the same group of antenna elements as a receiver circuit and its receiver switch. For example, switch 370 in FIG. 3 and switch 472 in FIG. 4 may both be coupled to antenna elements A1, A2 and A3 in group A of sectorized antenna 200 of FIG. 2. In such embodiments, it should be understood that switch 370 and switch 472 may be configured such that the switches never select the same antenna element at the same time. Thus, in such arrangement, and by utilizing only two separately configurable switches, transmitter circuit 310 may be transmitting in one configurable direction substantially simultaneously as receiver circuit 410 may be receiving in a different and separately configurable direction, thereby providing an extremely efficient and low cost communication system when coupled to, for example, multiple devices situated in different sectors of sectorized antenna 200 in FIG. 2, for example. Furthermore, this arrangement of transmitter and receiver circuits and switches may be applied to any number of differentiated groups of antenna elements, such as groups B and C of sectorized antenna 200 for example, and so provide the same separately configurable transmit and receive directionality for any defined sectors of sectorized antenna 200, for example.

Although switches 370 and 472 are depicted as SP3T switches, and sectorized antenna 200 is shown as comprising 9 antenna elements and 3 groups of antenna elements A, B and C, it should be understood that switches 370 and 472 may comprise switches able to couple to fewer or more than three antennas, for example, and a corresponding sectorized antenna may comprise fewer or more antenna elements as well as fewer or more groups of antenna elements. Furthermore, a number and size of sectors of a sectorized antenna may be determined by how such switches and antenna elements are arranged.

For example, in one embodiment, such as the one shown in FIG. 2, 9 antenna elements may be symmetrically grouped into 3 groups A, B and C comprising an equivalent number of antenna elements (e.g., 3), and each group may be coupled to a transceiver circuit by an SP3T switch, such as switches 370 and 472 of FIGS. 3 and 4. Where each SP3T switch must select at least one antenna element at all times, and where the SP3T switches are configured to select an adjacent selection of antenna elements (e.g., a selection of antenna elements that are each adjacent to at least one other antenna element in the selection) it follows that each sector of that embodiment may comprise 3 adjacent antenna elements comprising one antenna element from each group A, B and C, which, along with a distribution of individual antenna element characteristics, determines both a range of available sector directions and a size of each sector angle. However, this arrangement is not meant to limit the scope of the present inventive concepts. In other embodiments, different groups of antennas and different sector sizes, for example, may arise from different arrangements of even the same number and type of switches and antenna elements.

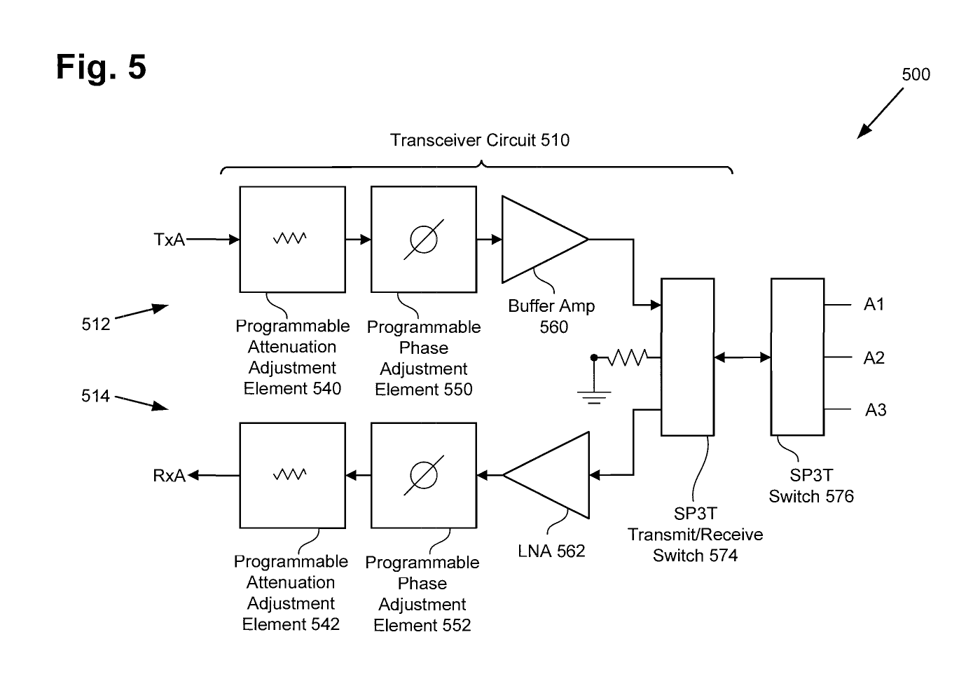

For example, FIG. 5 shows circuit diagram 500 including transceiver circuit 510 that may be selectively coupled to an antenna element in group A of sectorized antenna 200 in FIG. 2, for example, using SP3T switch 576 similar to switches 370 and 472 of FIGS. 3 and 4. Transceiver circuit 510 includes SP3T transmit/receive switch 574 configured to selectively couple a transmitter circuit (e.g., corresponding to transceiver circuit 310 in FIG. 3) and a receiver circuit (e.g., corresponding to receiver circuit 410 in FIG. 4) of transceiver circuit 510 to switch 576. As can be seen from FIG. 5, in some embodiments, transmit/receive switch 574 may comprise a SP3T switch similar to switch 576, but where one throw of transmit/receive switch 574 is coupled to ground (e.g., through a 50 Ohm resistor, for example). Thus, even though circuit diagram 500 comprises the same circuit elements as circuit diagrams 300 and 400 of FIGS. 3 and 4 combined (e.g., combined to provide transmit and receive functionality for group A of sectorized antenna 200 in FIG. 2, for example), embodiments of a sectorized antenna comprising transceiver circuit 510 may provide a configurable sector direction and sector angle size.

For example, where 3 transceiver circuits similar to transceiver circuit 510 are individually connected to antenna element groups A, B and C shown in FIG. 2, and by utilizing a transmit/receive switch like transmit/receive 574 to select a ground for a particular group of antenna elements, such embodiments may provide sectors comprising 1 antenna element, or 2 or 3 adjacent antenna elements, and may provide sector directions that lie either along individual antenna element propagation directions or along a direction half way between adjacent antenna element propagation directions, as explained previously. As such, embodiments of sectorized antennas including transceiver circuit 510 may comprise additional sectors and additional sector directions as compared to embodiments including transceiver circuits 310 and 410 of FIGS. 3 and 4. However, it should be noted that the embodiment shown in FIG. 5 does not include a capability of simultaneous and separately configurable transmit and receive directions within the same group of antenna elements, as is possible with previously described embodiments. Additionally, it should also be noted that in some embodiments, transmit/receive switch 574 may comprise a SP2T switch, such that resulting sector directions and sector angle sizes are the same as those of previously described embodiments. Thus, it should be clear that sectors of a sectorized antenna, according to the present inventive concepts, and thus a configurable directionality of such a sectorized antenna, may be defined not only by a number of antenna elements and their individualized characteristics, but also by any number of permutations of selectively coupling transceiver circuits to those antenna elements.

Because a sectorized antenna, according to embodiments of the present inventive concepts, comprises a configurable directionality, such sectorized antenna may be configured to have an increased overall coverage with respect to conventional antennas. For example, each individual antenna element of the sectorized antenna may be configured to have an effective range in a particular propagation direction that is much longer than that achievable by a conventional antenna. In particular, such antenna element may comprise a gain of more than 8 dB in an associated propagation direction, for instance, as compared to a conventional omnidirectional antenna, for example. Each sector of such a sectorized antenna may be selectively coupled to a transceiver circuit to leverage the extended propagation range of the individual antenna elements omnidirectionally, and thus such embodiments are relatively insusceptible to the misalignment issues typically associated with fixed, non-omnidirectional antennas, as explained above. However, such configurable directionality has additional benefits.

For example, in some embodiments, a configurable directionality of a sectorized antenna may be angularly narrow enough to minimize fading and shadow effects due to, for example, multipath transmissions and reflections, thus further increasing an effective range of such embodiments by decreasing common interference issues. Furthermore, such configurable directionality may be used to limit communications to a single external device at a particular time, minimizing network protocol issues, such as packet collisions, for example, and providing additional programmatic benefits. For instance, embodiments of the present inventive concepts may provide per device channel associations and tracking, which can be used to minimize interference between fixed devices, for example, or between fixed and actively mobile devices, for example.

As explained above, embodiments of the present inventive concepts may provide all these benefits yet be manufactured relatively compactly using inexpensive and readily available materials and fabrication methods, such as lithography of a metalized ground plane of a semiconductor wafer, for example. Thus, embodiments of the present inventive concepts may provide a low-cost and relatively compact antenna offering an increased effective range while being relatively insusceptible to misalignment and interference issues.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A sectorized antenna, the antenna comprising:
a plurality of antenna elements situated radially around a central axis, each of the plurality of antenna elements corresponding to at least one of another plurality of sectors of the antenna,
a first switch configured to selectively couple a first transceiver circuit to each antenna element in a first group of the plurality of antenna elements;
the selective coupling providing a configurable directionality for the antenna.

2. The antenna of claim 1, wherein the configurable directionality substantially extends 360 degrees around the central axis.

3. The antenna of claim 1, wherein at least one of the plurality of antenna elements comprises a Vivaldi antenna element.

4. The antenna of claim 1, wherein the plurality of antenna elements are configured to form a corresponding plurality of radiation patterns substantially isolated from one another.

5. The antenna of claim 1, wherein the plurality of antenna elements comprises a pattern formed in a contiguous layer of conductive material.

6. The antenna of claim 1, wherein at least one of the plurality of antenna elements comprises a microstrip fed antenna element.

7. The antenna of claim 1, wherein the first transceiver circuit comprises a transmit/receive switch configured to selectively couple a transmitter circuit and a receiver circuit of the transceiver circuit to the first switch.

8. The antenna of claim 1, wherein the first switch comprises a transmitter switch and the first transceiver circuit comprises a transmitter circuit, the antenna further comprising:
a receiver switch configured to selectively couple a receiver circuit to each antenna element in the first group;
the selective coupling providing substantially simultaneous and separately configurable transmit and receive directionality for the antenna.

9. The antenna of claim 1, wherein the first transceiver circuit comprises a programmable phase adjustment element and a programmable attenuation adjustment element.

10. The antenna of claim 1 further comprising:
a second switch configured to selectively couple a second transceiver circuit to each antenna element in a second group of the plurality of antenna elements different from the first group;
the first and second switches being configured to select one of the another plurality of sectors corresponding to a first antenna element of the first group adjacent to a second antenna element of the second group.

11. The antenna of claim 1 further comprising:
additional switches configured to selectively couple corresponding additional transceiver circuits to corresponding additional differentiated groups of the plurality of antenna elements;
the first and additional switches being configured to select one of the another plurality of sectors corresponding to a first antenna element of the first group and additional antenna elements of the additional differentiated groups, where the first and additional antenna elements form an adjacent selection of antenna elements.

12. A sectorized antenna, the antenna comprising:
a plurality of antenna elements situated radially around a central axis, each of the plurality of antenna elements corresponding to at least one of another plurality of sectors of the antenna,
a first switch configured to selectively couple a first transceiver circuit to each antenna element in a first group of the plurality of antenna elements;
a second switch configured to selectively couple a second transceiver circuit to each antenna element in a second group of the plurality of antenna elements different from the first group;
a third switch configured to selectively couple a third transceiver circuit to each antenna element in a third group of the plurality of antenna elements different from the first and second groups;
the selective coupling providing a configurable directionality for the antenna.

13. The antenna of claim 12, wherein the configurable directionality substantially extends 360 degrees around the central axis.

14. The antenna of claim 12, wherein at least one of the plurality of antenna elements comprises a Vivaldi antenna element.

15. The antenna of claim 12, wherein the plurality of antenna elements are configured to form a corresponding plurality of radiation patterns substantially isolated from one another.

16. The antenna of claim 12, wherein the plurality of antenna elements comprises a pattern formed in a contiguous layer of conductive material.

17. The antenna of claim 12, wherein at least one of the plurality of antenna elements comprises a microstrip fed antenna element.

18. The antenna of claim 12, wherein at least one of the first, second and third transceiver circuits comprises a transmit/receive switch configured to selectively couple a transmitter circuit and a receiver circuit of the corresponding transceiver circuit to the corresponding first, second or third switch.

19. The antenna of claim 12, wherein at least one of the first, second and third switches comprises a transmitter switch and the corresponding transceiver circuit comprises a transmitter circuit, the antenna further comprising:
a corresponding receiver switch configured to selectively couple a receiver circuit to each antenna element in the corresponding group of the plurality of antenna elements;
the selective coupling providing substantially simultaneous and separately configurable transmit and receive directionality for the antenna.

20. The antenna of claim 12, wherein at least one of the first, second and third transceiver circuits comprises a programmable phase adjustment element and a programmable attenuation adjustment element.

21. The antenna of claim 12, wherein each of the first, second and third groups comprise an equivalent number of antenna elements.

22. The antenna of claim 12, wherein the first, second and third switches are configured to select one of the another plurality of sectors corresponding to a first antenna element of the first group, a second antenna element of the second group and a third antenna element of the third group, where the first, second and third antenna elements form an adjacent selection of antenna elements.
